(19) United States
(12) Patent Application Publication
(10) Pub. No.: US 2010/0051808 A1
(43) Pub. Date: Mar. 4, 2010

(54) Imaging System Using Infrared Light

(75) Inventors: Herbert D. Zeman, Memphis, TN (US); Gunnar Lovhoiden, Berrien Springs, MI (US); Jeff D. Berryhill, Nesbit, MS (US)

Correspondence Address: BUTLER, SNOW, O'MARA, STEVENS & CANNADA PLLC, 6075 POPLAR AVENUE, SUITE 500, MEMPHIS, TN, 38119, US

(73) Assignee: LUMINETX CORPORATION, Memphis, TN (US)

(21) Appl. No.: 12/523,706

(22) PCT Filed: Oct. 20, 2008
(86) PCT No.: PCT/US08/80425

§ 371 Date: Nov. 4, 2009

Related U.S. Application Data
(60) Provisional application No. 60/981,282, filed on Oct. 19, 2007.

(51) Int. Cl. G02F 1/01

(52) U.S. Cl. 250/330

(57) ABSTRACT

An imaging system is disclosed for imaging buried structure, typically vasculature, below the surface of an object which can be skin, fat deposits, or other material and for projecting an image of the buried structure onto the surface of the object. Scanning lasers are used both to illuminate the object and to project an image onto it. One or more photodiodes measure the intensity of scattered and reflected light to create an image in conjunction with one or more of the scanning lasers.

### FIELD OF THE INVENTION

The present invention is generally directed to imaging subsurface structures using infrared light. More particularly, the invention is directed to a system for illuminating an object with infrared light, recording reflected infrared light, and then re-projecting the intensity of the recorded infrared light in the visible range.

### BACKGROUND OF THE INVENTION

Some medical procedures and treatments require a medical practitioner to locate a blood vessel in a patient's arm or other appendage. This can be a difficult task. especially when the blood vessel lies under significant deposits of subcutaneous fat. Previous imaging systems include the system described in U.S. Pat. No. 7,239,909 (hereby specifically incorporated by reference in its entirety) entitled Imaging System Using Diffuse Infrared Light. In that system diffuse infrared light is used to image vasculature below the surface of the skin and then reproject that image onto the skin to reveal the location of the vasculature. It was previously believed that illumination with diffuse infrared light was required for good imaging of vasculature underlying the skin. For that reason, it was believed that a vascular imaging system using a laser or array of lasers as the light source would not work due to the fact that a laser's light is very focused, essentially the opposite of diffuse. The inventor has discovered, however, that a laser or array of lasers producing substantially uniform infrared irradiation will also work. Irradiation would be considered substantially uniform, for the purposes of imaging vasculature, if the high spatial frequency variability is less than ±0.5%. A laser provides uniform irradiation in the very small area upon which it shines. By scanning a laser or an array of lasers, an image of the underlying vasculature can be recorded and projected on a pixel by pixel basis. If the intensity of the laser or each laser in an array of lasers is constant to ±0.5% or if the emitted intensity of the laser or each laser in an array of lasers is measured to allow correction for intensity variations then the average illumination by the scanning laser source would be uniform enough. By scanning the laser beam or beams, an image of a useful size can be generated.

### SUMMARY OF THE INVENTION

The results of this discovery is an apparatus using one or more lasers to provide infrared light towards an object, such as a patient, to enhance visibility of subcutaneous blood vessels. In one embodiment, the apparatus includes a first irradiating laser array for illuminating the body tissue with infrared light having a first wavelength in the range at which vasculature becomes apparent. Light which is reflected from the object is recorded by a first light sensing device for receiving light of the first wavelength. The first light sensing device then produces a first output representing the intensity of the recorded light. A first projecting laser array then projects a visible light representation of the first output onto the surface of the object.

In another embodiment, the apparatus includes a first irradiating laser array for illuminating the body tissue with infrared light having a first wavelength in the range at which vasculature becomes apparent, and a second irradiating laser array for illuminating the body tissue with infrared light having a second wavelength in the range of 1100 to 1700 nanometers. Light in those two wavelength ranges which is reflected from the object is then recorded by a first light sensing device which receives light of the first wavelength reflected from the object and a second light sensing device which receives light of the second wavelength reflected from the object. The first light sensing device creates a first output, and the second light sensing device creates a second output, each output representing the intensity of the light sensed by its respective light sensing device. The two outputs are then sent to an output comparer capable of comparing the first output and the second output to generate a compared output. Finally, a first projecting laser array projects a visible light representation of the compared output onto the surface of the object.

Using the invention described herein, subcutaneous blood vessels that are difficult or impossible to see under white light can be easily seen on the surface of the skin, enabling medical procedures such as the drawing of blood and i.v. placements, where the location of vasculature is important.

### BRIEF DESCRIPTION OF THE DRAWINGS

Further advantages of the invention will become apparent by reference to the detailed description of preferred embodiments when considered in conjunction with the drawings, which are not to scale, wherein like reference characters designate like or similar elements to the several drawings as follows:

FIG. 1 depicts an imaging system (12) for viewing an object under infrared illumination according to a preferred embodiment of the invention.

FIG. 2 depicts the imaging system (12) for viewing an object under infrared illumination according to another preferred embodiment of the invention.

### DETAILED DESCRIPTION OF THE PREFERRED EMBODIMENT

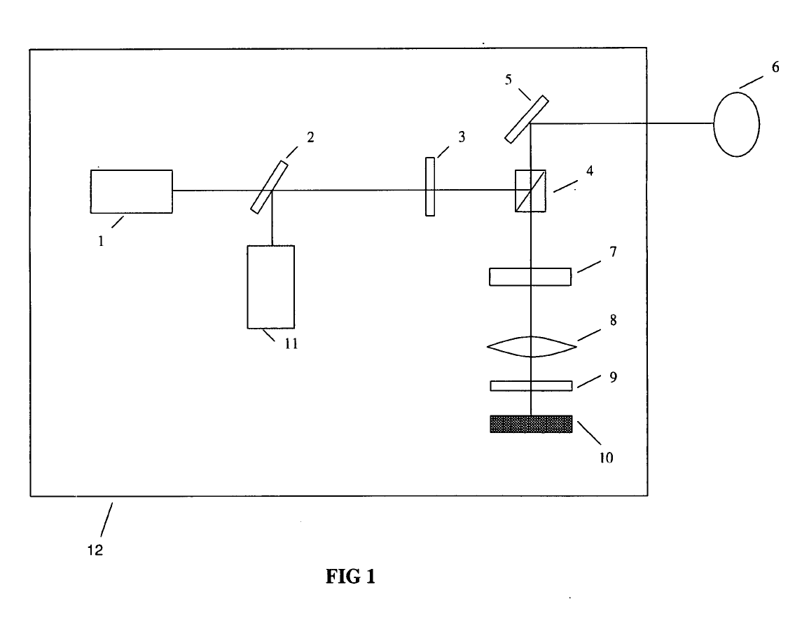

There is a range of infrared irradiation of the body in which skin and other body tissues reflect light but blood absorbs light. For example, infrared light in the range of about 700 to about 1100 nanometers is known to be reflected by the skin and absorbed by the blood. Thus, in video images of body tissue taken under infrared illumination in this range, blood vessels appear as dark lines against the lighter background of the surrounding flesh. The inventor has determined that when an area of body tissue is imaged in this infrared range under substantially uniform infrared illumination, vasculature becomes apparent. Shown in FIG. 1 is an imaging system (12) for illuminating an object (6), such as body tissue, with substantially uniform infrared light, for recording the intensity of reflected infrared light, and for projecting onto the body tissue invisible light. An image of a useful size is generated through use of a scanner (5) which may be a resonant mirror plus a mirror on a galvanometer, a digital micromirror device, such as a DLP chip, or any other device achieving the same result. As described in detail herein, when the object (6) is body tissue, blood vessels that are disposed below subcutaneous fat in the tissue may be clearly seen in a video image projected by the imaging system (12). For purposes of the descriptions of the preferred embodiments below, a “laser array” may be an array of one or more lasers. If any irradiating laser array in an embodiment consists of ‘n’ lasers in arrangement ‘x,’ then the corresponding light sensing device and projecting laser array will also consist of ‘n’ light sensing devices or lasers respectively in either arrangement ‘x’ or some reflection of arrangement ‘x.’

The imaging system (12) includes a first irradiating laser array (1) having a first wavelength in the range at which vasculature becomes apparent, a dichroic mirror (2) which transmits light in the infrared and reflects light in the visible, a polarizing filter (3), a polarizing beam splitter (4), a scanner (5), a polarizing filter (7), a lens (8), a narrow band filter (a) which transmits light of the wave length at which first irradiating laser array (1) is working, a first light sensing device (10) and a first projecting laser array (11). In one embodiment, the wavelength of the first irradiating laser array (1) is in the range of about 700 to 1100 nanometers, although this range is not the exclusive range at which first irradiating laser array (1) can operate for the invention to work. Vasculature can become apparent slightly above or slightly below this range as well. In the embodiment displayed in FIG. 1, the first irradiating laser array (1) generates infrared light which passes through dichroic mirror (2), through polarizing filter (3), and is then reflected off polarizing beam splitter (4) to the scanner (5). The scanner directs the light towards the object (6). The light is then reflected from the object (6) back to the scanner (5) which due to the speed of light is still in almost the same position. The light then passes through polarizing beam splitter (4), through polarizing filter (7), through the lens (8), through the narrow band filter (9), and its intensity is recorded by the first light sensing device (10). In this embodiment, the first light sensing device (10) can be a photodiode or any other light sensing device capable of detecting the intensity of received light. In this embodiment, the first light sensing device (10) can optionally be a silicon photodiode. Polarizing filter (7) has a polarization different from polarizing filter (3), and preferably orthogonal to polarizing filter (3), to reduce glare from light reflected from the object (6). A first output (not shown) representing the intensity measurement received by the first light sensing device (10) is transmitted through analog electronics (not shown) to first projecting laser array (11) which projects in the visible light range towards dichroic mirror (2) which reflects the image through polarizing filter (3), to polarizing beam splitter (4) which reflects the light to scanner (5) which reflects the light back to the object (6). Due the speed of light and the analog electronics (not shown), when the visible light is projected by first projecting laser array (11) to the object (6) it is projected to substantially the same place as the place from which the infrared light intensity was recorded. By scanning the light via scanner (5), an image can be produced on the object (6) of a useful size such that a section of the object (6) can be illuminated to show underlying vasculature.

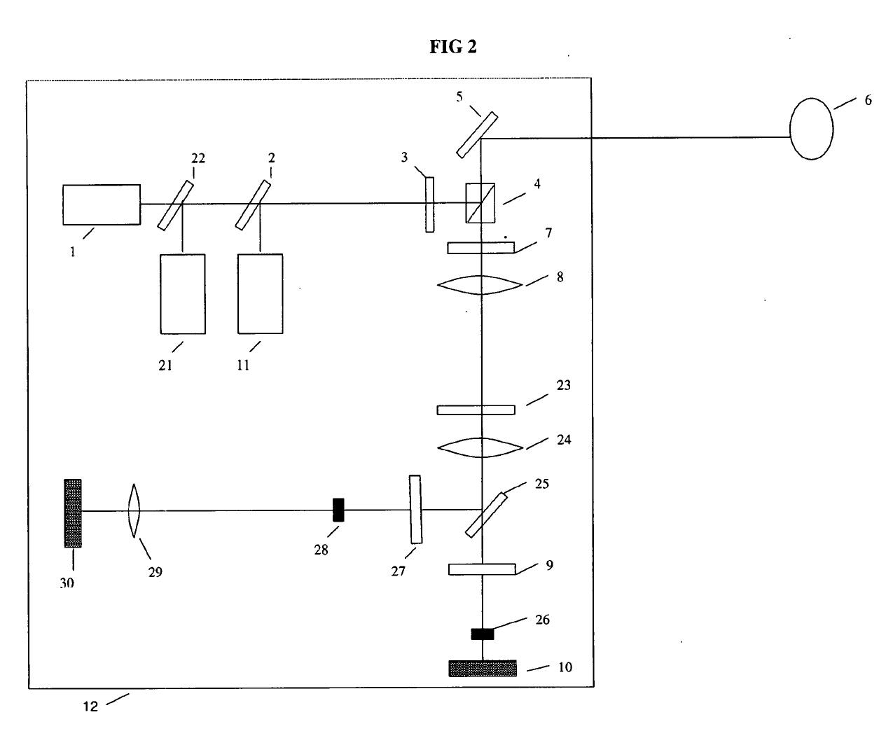

Another embodiment of the invention, depicted in FIG. 2, shows how the image comparison methods disclosed in the inventor's patent application published at US 2007-0158569 A1 on Jul. 12, 2007 in an application entitled Method and Apparatus for Projection of Subsurface Structure onto an Object's Surface. It also includes the use of optical stops (26) and (28) in front of the photodiodes to eliminate light that has not scattered significantly in the tissue. By eliminating unscattered or only slightly scattered light, the stop will reduce the contrast of shallow or surface features, allowing the contrast of deeper structures to be enhanced more.

The embodiment depicted in FIG. 2 works as follows. First, a first irradiating laser array (1) and a second irradiating laser array (21) generate infrared light. The first irradiating laser array (1) emits light having a first wavelength in the range at which vasculature becomes apparent. The second irradiating laser array (21) emits light in the range of 1100 to 1700 nanometers. The light emitted by first irradiating laser array (1) passes through a dichroic mirror (22), and the light emitted by second irradiating laser array (21) is reflected from the dichroic mirror (22). The dichroic mirror (22) has the property of transmitting light in the range at which first irradiating laser array (1) is emitting and reflecting light in the range at which second irradiating laser array (21) is emitting. The combined light which has reflected off of or passed through dichroic mirror (22) then passes through dichroic mirror (2). Dichroic mirror (2) has the property of transmitting light in the range at which first irradiating laser array (1) and second irradiating laser array (21) are emitting and reflecting light in the range at which a first projecting laser array (11) is emitting. First projecting laser array (11) is discussed more below. The light passing through dichroic mirror (2) passes through polarizing filter (3) to polarizing beam splitter (4). The light which is reflected by polarizing beam splitter (4) is reflected by scanner (5) to the object (6) which is to be imaged.

Light which is reflected from the object (6) then reflects back to the scanner (5) and through polarizing beam splitter (4). It then passes through polarizing filter (7) which transmits light of a polarization different from polarizing filter (3) and preferably of an orthogonal polarization thereto. The light then passes through a lens (8) and, optionally, a long wavelength pass filter (23). The light passing through the long wavelength pass filter (23) then passes in one embodiment through a microscope objective (24) to a dichroic mirror (25) which transmits light in the range at which first irradiating laser array (1) is emitting and reflects light in the range at which second irradiating laser array (21) is emitting. The light transmitted by dichroic mirror (25) passes through a narrow band filter (9) which allows light to pass through which is in the range at which first irradiating laser array (1) is transmitting. The light passing through narrow band filter (9) then passes by an optical stop (26) to first light sensing device (10) which measures the intensity of the received light. The light which is reflected from dichroic mirror (25) passes through narrow band filter (27) which transmits light of the wavelength at which second irradiating laser array (21) is emitting. That light passing through narrow band filter (27) then passes by optical stop (28), through focusing lens (29) to second light sensing device (30) which records the intensity of the received light. In this embodiment, the second light sensing device (300 can be a photodiode or any other light sensing device which can measure the intensity of the received light. Each of the optical stops (26) and (28) can be a small object, a spatial light modulator such as a DLP chip, an LCOS chip, or a transmissive LCD chip, or any other optical stop which can achieve a similar result of blocking a portion of the transmitted light. If a optical stop (26) or (28) is a small object, such as a wire or a very small inscribed or printed dot, the microscope objective (24) magnifies the received light such that the optical stop eliminates only the center of the beam of received light, and, due to the typically small size of photodiodes operating in the 1100 to 1700 nanometer range, the focusing lens (29) focuses the light onto the second light sensing device (30) to ensure that enough light is gathered. If both optical stops (26) and (28) are digital micromirror devices, such as the DLP made by Texas Instruments, or a LCOS chip or transmissive LCD chip, then the microscope objective (24) and focusing lens (29) may be eliminated. In this embodiment, the first light sensing device (10) can optionally be a silicon photodiode, and the second light sensing device (30) can be an indium-gallium-arsenide photodiode.

The first light sensing device (10) and second light sensing device (30) each emit a respective first output and second output (not shown) representing the intensity of the light which they have received. These first output and second output are compared by the output comparer (not shown) in the method described in published patent application US 2007-0158569 A1 published on Jul. 12, 2007, entitled Method and Apparatus for Projection of Subsurface Structure onto an Object's Surface (hereby incorporated by reference in its entirety) at paragraphs [0670] to [0690] to create a compared output. The output comparer (not shown) may be analog electronics, digital electronics, a computer, or any other device capable of comparing the outputs in the disclosed way. This comparison may be done digitally or otherwise.

The output comparer (not shown) sends the compared output to control first projecting laser array (11) which emits light in the visible range. The light emitted by first projecting laser array (11) reflects from dichroic mirror (2) to pass through polarizing filter (3), reflect from polarizing beam splitter (4), reflect from scanner (5) and shine on the object (6). If the mirrors of scanner (5) are not still in the same position by this point, the light may be skewed between polarizing beam splitter (4) and scanner (5) to align the light such that it arrives at the proper spot on the object.

As for the use of a spatial light modulator such as a DLP chip, a LCOS chip, or a transmissive LCD chip as an optical stop (26) or (28), it provides multiple advantages. First, such devices allow for blocking of tiny portions of the light beam without first magnifying the beam and may be adjusted to block a larger or smaller amount of the beam. In addition, at least with the use of a DLP chip, light which is not transmitted is not lost. When a DLP chip or similar chip is used, it is possible to add one or more additional light sensing devices (not shown) to collect diverted light to use in image generation. Of course, the ray traces of light in FIG. 2 may vary if a DLP chip or other spatial light modulator is used as one or both of the optical stops (26) or (28). In the case of a DLP chip optical stop, for example, the photodiodes would receive light reflected from the appropriate tiny mirrors of the DLP chip, so the first light sensing device (10) and/or the second light sensing device (30) collecting the un-blocked light would probably not be on axis with the light arriving at the corresponding optical stops (26) and/or (28).

It should be understood that features of any of these embodiments may be used with another in a way that will now be understood in view of the foregoing disclosure. For example, any embodiment could work with or without optical stops.

Although the present invention has been described and illustrated with respect to at least one preferred embodiment and uses therefore, it is not to be so limited since modifications and changes can be made therein which are within the full intended scope of the invention.

We claim:

1. An apparatus to enhance the visibility of a buried structure beneath the surface of an object comprising:
a first irradiating laser array comprising at least one laser irradiating light having a first property towards an object;
a first light sensing device for receiving light having a first property;
a first projecting laser array comprising at least one laser irradiating light having a second property towards an object; and
an optical stop oriented to prevent a portion of the light having a first property reflected from the object from reaching the first light sensing device.

2. The apparatus of claim 1 wherein the first irradiating laser array comprises one laser.

3. The apparatus of claim 1 wherein the first irradiating laser array comprises more than one laser.

4. The apparatus of claim 1 wherein the first projecting laser array comprises one laser.

5. The apparatus of claim 1 wherein the first projecting laser array comprises more than one laser.

6. The apparatus of claim 1 wherein the first property is a wavelength in which vasculature is detectible.

7. The apparatus of claim 1 wherein the second property is a wavelength in which the light is visible.

8. The apparatus of claim 1 wherein the optical stop comprises is a DLP chip.

9. The apparatus of claim 8 further comprising:
a second light sensing device for receiving the light directed away from the first light sensing device by the optical stop.

10. The apparatus of claim 1 wherein the object is a living organism and the buried structure is vasculature.

11. An apparatus to enhance the visibility of a buried structure beneath the surface of an object comprising:
a first irradiating laser array comprising at least one laser irradiating light having a first property towards an object;
a first light sensing device for receiving light having a first property and outputting first data;
a second irradiating laser array comprising at least one laser irradiating light having a second property towards an object;
a second light sensing device for receiving light having a second property and outputting second data;
a computer for comparing the first data and the second data; and
a first projecting laser array comprising at least one laser irradiating light having a third property towards an object.

12. The apparatus of claim 11 further comprising a first optical stop oriented to prevent a portion of the light having a first property reflected from the object from reaching the first light sensing device.

13. The apparatus of claim 12 further comprising a second optical stop oriented to prevent a portion of the light having a second property reflected from the object from reaching the second light sensing device.

14. The apparatus of claim 11 further comprising an optical stop oriented to prevent a portion of the light having a second property reflected from the object from reaching the second light sensing device.

15. The apparatus of claim 11 wherein the first irradiating laser array comprises one laser.

16. The apparatus of claim 11 wherein the first irradiating laser array comprises more than one laser.

17. The apparatus of claim 11 wherein the second irradiating laser array comprises one laser.

18. The apparatus of claim 11 wherein the second irradiating laser array comprises more than one laser.

19. The apparatus of claim 12 wherein the first optical stop is a DLP chip.

20. The apparatus of claim 19 further comprising:
a third light sensing device for receiving the light directed away from the first light sensing device by the first optical stop.

21. The apparatus of claim 13 wherein the first optical stop is a first DLP chip and the second optical stop is a second DLP chip.

22. The apparatus of claim 21 further comprising:
a third light sensing device for receiving the light directed away from the first light sensing device by the first optical stop; and
a fourth light sensing device for receiving the light directed away from the second light sensing device by the second optical stop.

23. The apparatus of claim 14 wherein the optical stop is a DLP chip.

24. The apparatus of claim 23 further comprising:
a third light sensing device for receiving the light directed away from the second light sensing device by the optical stop.
